(19) United States
(12) Patent Application Publication
(10) Pub. No.: US 2026/0267714 A1
(43) Pub. Date: Sep. 10, 2026

(54) CENTRALIZED VIRTUAL ASSISTANT FOR MANAGING SERVICES

(71) Applicant: Honeywell International Inc., Charlotte, NC (US)

(72) Inventor: Mandar Vartak, Bangalore (IN)

(21) Appl. No.: 19/074,446

(22) Filed: Mar. 10, 2025

(51) Int. Cl. G06F 9/54; G06F 40/30

(52) U.S. Cl. CPC G06F 9/54; G06F 40/30

(57) ABSTRACT

A system and a method of managing services using a centralized assistant are described. The method includes deploying a plurality of virtual assistants, each virtual assistant is configured to provide information related to one of a plurality of operations running in an industry. The centralized virtual assistant receives a user query related to one or more operations. The user query is processed using a Machine Learning (ML) technique to determine an intent. The intent is mapped to Application Programming Interfaces (APIs) of the plurality of virtual assistants, and the user query is broadcasted to the plurality of virtual assistants by making API calls. Responses of the plurality of virtual assistants to the user query and confidence scores associated with the responses are received, and an optimal response is determined based on the confidence scores associated with the responses.

### TECHNICAL FIELD

Present disclosure relates to virtual assistants, and more specifically relates to a virtual assistant for managing services in an enterprise.

### BACKGROUND

Within an enterprise, different operations run in different units or departments. Though the units are associated with each other in some manner, operational information associated with a unit is available only to an assigned operator or individual. An operator responsible for overseeing an operation in one unit would not have access to operational information related to another unit. For example, the different units in an enterprise may include planning, operations, production, engineering, technical services, and IT. An operator responsible for managing an operation or a service in engineering unit would not have access to operational information of planning or operations units. Therefore, the operators do not have holistic access of complete operational information related to an enterprise.

The operators are often required to take decisions in a real-time for controlling assigned operations, for example adjusting operational parameters related to a machinery installed in the enterprise. Because the operators do not have holistic access of the complete operational information, they are required to take actions solely based on limited information available to them. Further, an experienced operator may take appropriate actions in real-time, however an inexperienced operator struggles to operate a machinery without any guidance.

Thus, a system and a method of addressing the above-mentioned challenges are needed.

### SUMMARY OF THE INVENTION

In one embodiment, a method of managing services using a centralized virtual assistant is described. The method includes deploying a plurality of virtual assistants. Each virtual assistant is configured to provide information related to one of a plurality of operations running in an enterprise. The method further includes receiving, at a centralized virtual assistant, a user query related to one or more operations of the plurality of operations. The method further includes processing the user query using a Machine Learning (ML) technique to determine an intent. The method further includes mapping the intent to Application Programming Interfaces (APIs) of the plurality of virtual assistants. The method further includes broadcasting the user query to the plurality of virtual assistants by making API calls. The method further includes receiving responses from the plurality of virtual assistants for the user query and confidence scores associated with the responses. The method further includes determining an optimal response based on the confidence scores associated with the responses. The method further includes providing the optimal response to the user.

In an aspect, the plurality of virtual assistants includes Advanced Process Control (APC) agent, operations management agent, production management agent, and maintenance management agent.

In an aspect, the optimal response is a response, of the responses, associated with a confidence score of highest value.

In an aspect, the optimal response is determined by identifying two or more responses having confidence scores greater than a predefined cut-off value; and aggregating information of the two or more responses.

In an aspect, the user query is for obtaining status updates, operational guidance, and root cause identification.

In an aspect, the method further includes generating a Natural Language Processing (NLP) response using the optimal response, and providing the NLP response to the user.

In an aspect, the method further includes requesting the user to enrich the user query when the intent cannot be determined from available content of the user query.

In an aspect, the user query and the optimal response are present in one of text format and audio format.

In one embodiment, a system for managing services using a centralized virtual assistant is described. The system comprises a processor and a memory coupled with the memory. The memory stores program instructions configured to deploy a plurality of virtual assistants. Each virtual assistant is configured to provide information related to one of a plurality of operations running in an enterprise. The memory further stores program instructions configured to receive, at a centralized virtual assistant, a user query related to one or more operations of the plurality of operations. The memory further stores program instructions configured to process the user query using a Machine Learning (ML) technique to determine an intent. The memory further stores program instructions configured to map the intent to Application Programming Interfaces (APIs) of the plurality of virtual assistants. The memory further stores program instructions configured to broadcast the user query to the plurality of virtual assistants by making API calls. The memory further stores program instructions configured to receive responses from the plurality of virtual assistants for the user query and confidence scores associated with the responses. The memory further stores program instructions configured to determine an optimal response based on the confidence scores associated with the responses, and provide the optimal response to the user.

In an aspect, the plurality of virtual assistants includes Advanced Process Control (APC) agent, operations management agent, production management agent, and maintenance management agent.

In an aspect, the optimal response is a response, of the responses, associated with a confidence score of highest value.

In an aspect, the optimal response is determined by identifying two or more responses having confidence scores greater than a predefined cut-off value; and aggregating information of the two or more responses.

In an aspect, the user query is for obtaining status updates, operational guidance, and root cause identification.

In an aspect, the memory further stores program instructions configured to generate a Natural Language Processing (NLP) response using the optimal response, and providing the NLP response to the user.

In an aspect, the memory further stores program instructions configured to request the user to enrich the user query when the intent cannot be determined from available content of the user query.

In an aspect, the user query and the optimal response are present in one of text format and audio format.

In one embodiment, a non-transitory computer-readable storage medium for managing services using a centralized virtual assistant is described. The non-transitory computer-readable storage medium comprises a computer program code for execution by one or more processors of an apparatus. The computer program code is configured to, when executed by the one or more processors, cause the apparatus to deploy a plurality of virtual assistants. Each virtual assistant is configured to provide information related to one of a plurality of operations running in an enterprise. The computer program code is further configured to receive, at a centralized virtual assistant, a user query related to one or more operations of the plurality of operations. The computer program code is further configured to process the user query using a Machine Learning (ML) technique to determine an intent. The computer program code is further configured to map the intent to Application Programming Interfaces (APIs) of the plurality of virtual assistants. The computer program code is further configured to broadcast the user query to the plurality of virtual assistants by making API calls. The computer program code is further configured to receive responses from the plurality of virtual assistants for the user query and confidence scores associated with the responses. The computer program code is further configured to determine an optimal response based on the confidence scores associated with the responses, and provide the optimal response to the user.

In an aspect, the plurality of virtual assistants includes Advanced Process Control (APC) agent, operations management agent, production management agent, and maintenance management agent.

### BRIEF DESCRIPTION OF THE DRAWINGS

The accompanying drawings constitute a part of the description and are used to provide further understanding of the present disclosure. Such accompanying drawings illustrate the embodiments of the present disclosure which are used to describe the principles of the present disclosure. The embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one. In the drawings:

FIG. 1 illustrates a network connection diagram of a system for implementing and operating a centralized virtual assistant for managing different services running in an enterprise, in accordance with an embodiment of the present disclosure;

FIG. 2 illustrates a block diagram of an example computing device for implementing and operating the centralized virtual assistant, in accordance with an embodiment of the present disclosure;

FIG. 3 illustrates a block diagram of the computing device storing program instructions for implementing and operating the centralized virtual assistant for managing services, in accordance with an embodiment of the present disclosure;

FIGS. 4a and 4b cumulatively illustrate an information flow diagram of a first method of implementing and operating a centralized virtual assistant for managing different services running in an enterprise, in accordance with an embodiment of the present disclosure;

FIGS. 5a and 5b cumulatively illustrate an information flow diagram of a second method of implementing and operating a centralized virtual assistant for managing different services running in an enterprise, in accordance with an embodiment of the present disclosure;

FIGS. 6a through 6d illustrate different use case scenarios of the centralized virtualized assistant for managing services, in accordance with an embodiment of the present disclosure; and

FIGS. 7a and 7b cumulatively illustrate a flow chart of a method of implementing and utilizing a centralized virtualized assistant for managing services, in accordance with an embodiment of the present disclosure.

### DETAILED DESCRIPTION OF THE INVENTION

The present disclosure provides a system and a method of implementing and operating a centralized virtual assistant for managing different services running in an enterprise. The centralized virtual assistant may be configured to communicate with multiple virtual assistants configured for monitoring different operations running in an enterprise. Each virtual assistant may be configured to perform a specific task and provide specific assistance to users/operators.

During operation, a user may submit a user query related to an operation running in the enterprise. In some scenarios, the user query may be submitted for obtaining status updates, operational guidance, or root cause identification. After receiving the user query, the centralized virtual assistant accesses an Artificial Intelligence (AI) engine to process the user query to determine an intent i.e. objective of the user query.

After the intent is determined from the user query, the centralized virtual assistant maps the intent to Application Programming Interfaces (APIs) of one or more of the multiple virtual assistants, for making API calls. In this manner, the centralized virtual assistant broadcasts the user query to relevant virtual assistants for obtaining responses to the user query. Relevant virtual assistants refer to the virtual assistants responsible for providing information/assistance matching with or related to the user query. The centralized virtual assistant identifies the relevant virtual assistants from information stored in a knowledge database i.e. a repository storing details of functionalities of all the virtual assistants.

Based on their predefined functionality/configurations, one or more of the virtual assistants determine responses to the user query. Each virtual assistant provides a response along with a confidence score. The confidence scores would indicate a probability/likelihood of accuracy of the response determined by the virtual assistant. The centralized virtual assistant receives the responses and the confidence scores associated with the responses, and determines an optimal response from the responses, based on the confidence scores. In one implementation, the optimal response may be a response associated with a confidence score of highest value. In another implementation, the optimal response may be determined by collating information present in different responses associated with confidence scores greater than a predefined cut-off value. The optimal response would be processed using the AI engine for performing Natural Language Processing (NLP). Finally, the centralized virtual assistant provides an NLP response to the user, in response to the user query.

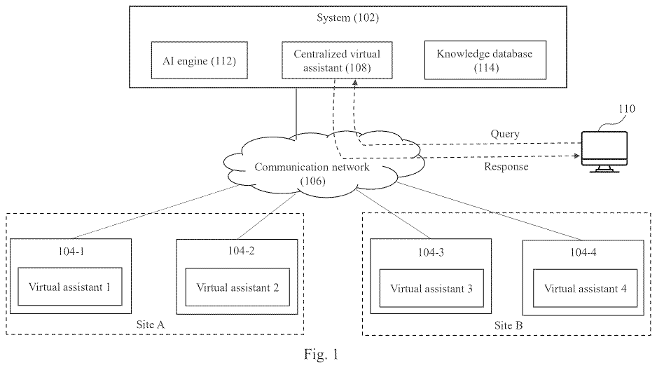

FIG. 1 illustrates a network connection diagram of a system 102 for implementing and operating a centralized virtual assistant for managing different services running in an enterprise, in accordance with an embodiment of the present invention. The system 102 may be a data processing device such as a server. The server may be implemented locally or over a cloud network. The system 102 may communicate with several device 104-1 to 104-4 (collectively referred as devices 104) operating in an enterprise. For example, device 104-1 may host a virtual assistant 1 and device 104-2 may host a virtual assistant 2, each virtual assistant responsible for managing a service related to assets operating in a site A of the enterprise. Similarly, device 104-3 may host a virtual assistant 3 and device 104-2 may host a virtual assistant 3, for managing a service related to assets operating in a site B of the enterprise.

The system 102 may communicate with the devices 104 through a communication network 106. The communication network 106 may be a wired and/or a wireless network. The communication network 106 may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art.

The communication network 106 may utilize network components to establish connection between the system 102 and the devices 104. The network components may include, hubs, switches, routers, bridges, and repeaters. The routers may be of different types such as Provide Edge (PE) routers, Customer Edge (CE) routers, and intermediate routers. The switches and the routers are primary network components, wherein the switches are used to connect the user device present within a network, and the routers are used to connect multiple networks.

The system 102 may host a centralized virtual assistant 108. The centralized virtual assistant 108 may be accessible through a User Interface (UI) provided over a user device 110. The centralized virtual assistant may be configured to communicate 108, through the communication network 106, with the virtual assistants 104 configured for monitoring different operations running in the enterprise. For example, the virtual assistants 104 may include Advanced Process Control (APC) agent, operations management agent, production management agent, and maintenance management agent. Each of the virtual assistants 104 may be configured to perform a specific task and provide specific assistance to users/operators. For example, the production management agent may be responsible for monitoring different production related activities in the enterprise and provide details of the production related activities to the users. Similarly, the maintenance management agent may be responsible for monitoring different maintenance related activities and provide details of the maintenance related activities to the user(s).

During operation, a user may submit, by accessing the UI of the user device 110, a user query related to an operation running in the enterprise. In some scenarios, the user query may be submitted for obtaining status updates, operational guidance, or root cause identification. After receiving the user query, the centralized virtual assistant 108 accesses an Artificial Intelligence (AI) engine 112 to process the user query. The AI engine 112 processes the user query to determine an intent i.e. objective of the user query. In case the centralized virtual assistant 108 is unable to determine the intent from information/content available in the user query, the centralized virtual assistant 108 may request the user to enrich the user query. The user may enrich the user query by supplementing additional or specific details. For example, while seeking maintenance related information, the user may also indicate a unit whose maintenance related information is required.

After the intent is determined from the user query, the centralized virtual assistant 108 maps the intent to Application Programming Interfaces (APIs) of one or more of the virtual assistants 104, for making API calls. In this manner, the centralized virtual assistant 108 broadcasts the user query to relevant virtual assistants for obtaining responses to the user query. Relevant virtual assistants refer to virtual assistants responsible for providing information/assistance matching with or related to the user query. The centralized virtual assistant 108 may identify the relevant virtual assistants from information stored in a knowledge database 114 i.e. a repository storing details of functionalities of all the virtual assistants 104.

Based on their predefined functionality/configurations, one or more of the virtual assistants 104 determine responses to the user query. Each of the virtual assistants 104 processing the user query provides a response along with a confidence score. The confidence score would indicate a probability/likelihood of an accuracy of response determined by a virtual assistant. The centralized virtual assistant 108 receives responses of the virtual assistants 104 and confidence scores associated with the responses, and determines an optimal response from the responses, based on the confidence scores. In one implementation, the optimal response may be a response associated with a confidence score of highest value. In another implementation, the optimal response may be determined by collating information present in different responses associated with confidence scores greater than a predefined cut-off value. The optimal response would be processed by the AI engine 112 performing Natural Language Processing (NLP). Finally, the centralized virtual assistant 108 provides an NLP response to the user, in response to the user query.

By implementing the above-described functionality, the centralized virtual assistant 108 provides a single point of service for obtaining information required by any user/operator in an enterprise.

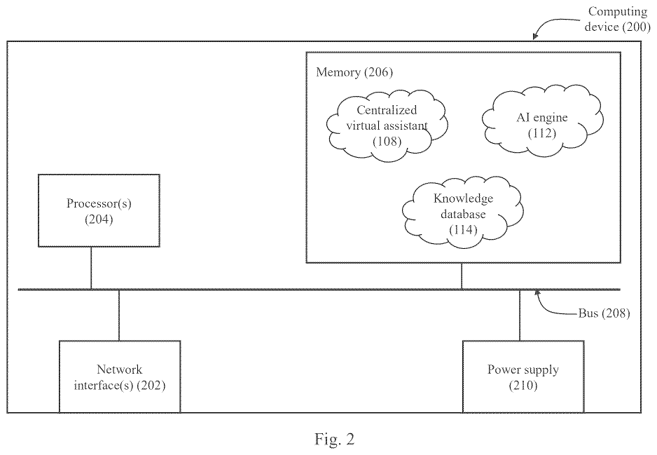

FIG. 2 illustrates a block diagram of an example computing device 200 (similar to the system 102) for implementing and operating a centralized virtual assistant for managing different services running in an enterprise, in accordance with an embodiment of the present disclosure. The computing device 200 may be implemented over a cloud network. The computing device 200 may comprise one or more network interfaces 202 (e.g., wired, wireless, etc.), at least one processor 204, a memory 206 interconnected by a system bus 208, and a power supply 210.

The one or more network interfaces 202 may be used to provide input or fetch output from the computing device 200. The one or more network interfaces 202 may be implemented as a Command Line Interface (CLI) or a Graphical User Interface (GUI). Further, Application Programming Interfaces (APIs) may also be used for remotely interacting with edge systems and cloud servers.

The processor 204 may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

The memory 206 may include, but is not limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The memory 206 comprises a plurality of storage locations that are addressable by the processor 204 and the network interfaces 202 for storing software programs and other necessary information associated with the embodiments described herein. For example, the memory 206 stores executable versions of the centralized virtual assistant 108 and the AI engine 112, and also implements the knowledge database 114. The processor 204 may comprise hardware elements or hardware logic adapted to execute the software programs and manipulate data structures.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

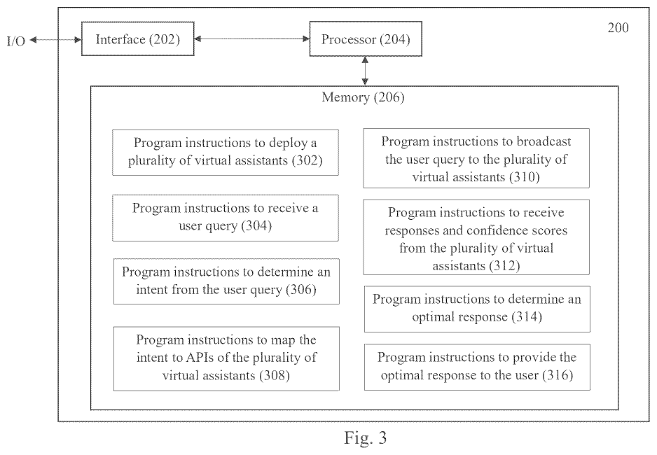

FIG. 3 illustrates a block diagram of the computing device 200 storing program instructions for implementing and operating a centralized virtual assistant for managing services, in accordance with an embodiment of the present disclosure. The memory 206 of the computing device 200 may store program instructions for performing several functions associated with management of the services. Functional code stored in the memory 206 may include program instructions to deploy a plurality of virtual assistants 302, program instructions to receive a user query 304, program instructions to determine an intent from the user query 306, program instructions to map the intent to APIs of the plurality of virtual assistants 308, program instructions to broadcast the user query to the plurality of virtual assistants 310, program instructions to receive responses and confidence scores from the plurality of virtual assistants 312, program instructions to determine an optimal response 314, and program instructions to provide the optimal response to the user 316.

The program instructions to deploy a plurality of virtual assistants 302 may cause the processor 204 to deploy a plurality of virtual assistants. Each virtual assistant is configured to provide information related to one of a plurality of operations running in an enterprise. The program instructions to receive a user query 304 may cause the processor 204 to receive, at a centralized virtual assistant, a user query related to one or more operations of the plurality of operations. The program instructions to determine an intent from the user query 306 may cause the processor 204 to process the user query using a Machine Learning (ML) technique to determine an intent. The program instructions to map the intent to APIs of the plurality of virtual assistants 308 may cause the processor 204 to map the intent to Application Programming Interfaces (APIs) of the plurality of virtual assistants.

The program instructions to broadcast the user query to the plurality of virtual assistants 310 may cause the processor 204 to broadcast the user query to the plurality of virtual assistants by making API calls. The program instructions to receive responses and confidence scores from the plurality of virtual assistants 312 may cause the processor 204 to receive responses from the plurality of virtual assistants for the user query and confidence scores associated with the responses. The program instructions to determine an optimal response 314 may cause the processor 204 to determine an optimal response based on the confidence scores associated with the responses. The program instructions to provide the optimal response to the user 316 may cause the processor 204 to provide the optimal response to the user.

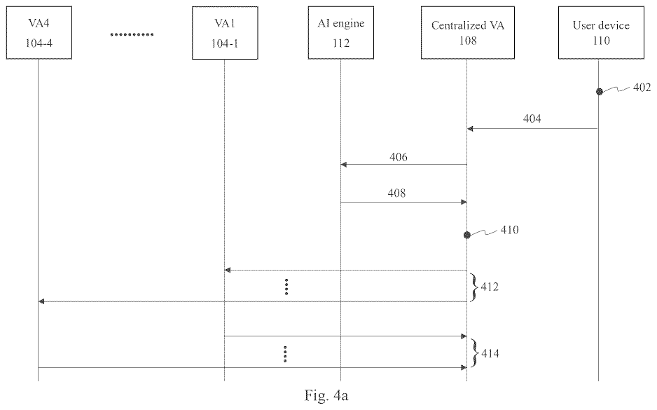

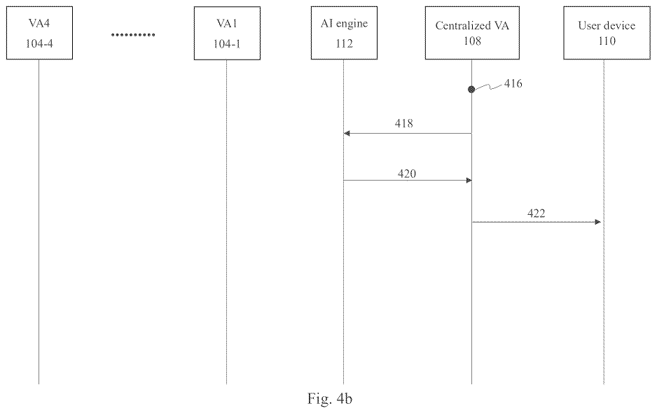

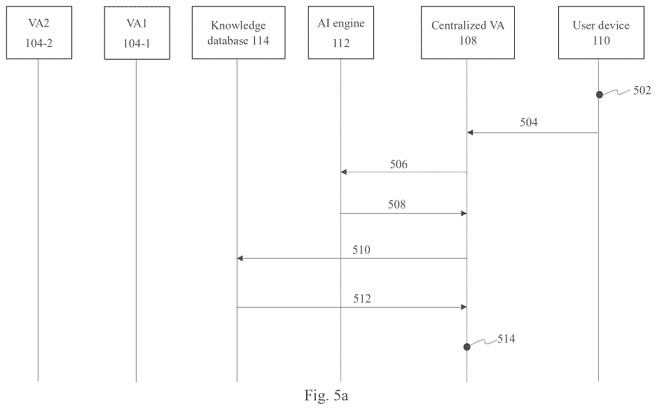

A detailed explanation of the method is provided successively with reference to FIGS. 4a and 4b and FIGS. 5a and 5b.

FIGS. 4a and 4b cumulatively illustrate an information flow diagram of a first method of implementing and operating a centralized virtual assistant for managing different services running in an enterprise, in accordance with an embodiment of the present disclosure. The first method begins with step 402 where a user submits a user query on the user device 110. The user query may be provided in a text or audio format. When provided in an audio format, audio to text conversion is performed using a suitable technique. The user query may be related to an operation running in the enterprise. For example, the user query may be submitted for obtaining status updates, operational guidance, or root cause identification. The user device 110 communicates the user query to the centralized virtual assistant 108, at step 404. The centralized virtual assistant 108 may be hosted over a locally implemented or cloud-based computing device system, for example the system 102. The centralized virtual assistant 108 is a software application designed to handle various tasks and provide services through a single, centralized interface, by interacting with multiple virtual assistants 104.

The virtual assistants 104 may correspond to software applications configured for monitoring different operations running in the enterprise. For example, the virtual assistants 104 may include Advanced Process Control (APC) agent, operations management agent, production management agent, and maintenance management agent.

APC refers to a suite of sophisticated control strategies and technologies used in industrial and manufacturing environments to improve the efficiency, stability, and optimization of complex processes. Unlike traditional process control systems, which typically focus on basic control loops (like temperature or pressure regulation), APC aims to manage and optimize the entire process more effectively by considering multiple variables and their interactions. APC often incorporates real-time data, predictive models, and advanced algorithms to improve operational performance.

Operations management refers to a set of activities and services aimed at efficiently managing the production and delivery of goods and services within an organization. Operations management focuses on overseeing, controlling, and optimizing all processes involved in the transformation of inputs (such as raw materials, labor, and technology) into finished products or services. The goal of operations management is to maximize efficiency, reduce costs, improve quality, and meet customer demands while maintaining profitability.

Production management refers to a set of services and practices designed to plan, coordinate, and control the manufacturing or production process to ensure that products are produced efficiently, on time, and within budget. Production management encompasses various activities and techniques aimed at optimizing production workflows, managing resources effectively, maintaining quality standards, and meeting customer demand. Through production management, it is ensured that the production process operates smoothly and efficiently, maximizing output while minimizing waste, downtime, and costs.

Maintenance management refers to a set of practices and processes designed to ensure the efficient and reliable operation of an organization's assets, equipment, and facilities. Maintenance management involves strategic planning, scheduling, monitoring, and optimizing maintenance activities to ensure that all equipment and infrastructure are functioning properly and cost-effectively. Primary objective of maintenance management is to minimize downtime, extend the lifespan of equipment, optimize performance, and reduce repair costs, all while ensuring safety and compliance with industry standards.

Each of the virtual assistants 104 may be configured to perform a specific task and provide specific assistance to users/operators. For example, the production management agent may be responsible for monitoring different production related activities in the enterprise and provide details of the production related activities to the users. Similarly, the maintenance management agent may be responsible for monitoring different maintenance related activities and provide details of the maintenance related activities to the user(s).

After receiving the user query, the centralized virtual assistant 108 sends a request to the AI engine 112 to process the user query, at step 406. The AI engine 112 refers to an AI based software application for processing the user query. The user query may be processed to determine an intent i.e. objective of the user query. To determine the intent, the AI engine 112 may perform a variety of steps including data collection and labelling. During the data collection and labelling, data may be gathered from a diverse set of queries or user inputs representing the kinds of interactions that are expected. Such data can be collected from past conversations, customer service logs, or synthetic data generation procedures. Labelling of the data may involve manual annotation of the queries with correct intent labels. For example, queries like “what's the boiler temperature?” could be labeled with an intent “System query”, and “when is the boiler expected to be working” would be labeled with “Maintenance query”.

Successively, the AI engine 112 may perform text pre-processing. Text pre-processing may involve tokenization i.e. splitting of the user query into individual words or tokens, and lemmatization/stemming i.e. reducing words to their base or root form. Thereafter, the the AI engine 112 may perform feature extraction. Feature extraction is performed for conversion of textual content into numerical features so that the user query could be fed to a machine learning model. Feature extraction may be performed using Bag of Words (BoW) i.e. representing text by counting frequency of each word in the user query. Alternatively, feature extraction may be performed using word embeddings where pre-trained embeddings like Word2Vec, GloVe, or BERT could be used to represent words in a continuous vector space, to capture semantic relationships between words.

Successively, the AI engine 112 may perform model selection and training. Intent detection is typically a classification task, and thus supervised Machine Learning (ML) algorithms can be used. For example, Logistic Regression, Support Vector Machine (SVM), Naive Bayes, and deep learning could be used. Using a suitable ML algorithm, an ML model could be implemented, successively trained, evaluated, and deployed. Upon deployment, the AI model (i.e. the AI engine 112) may classify incoming user queries in real-time i.e. determine the intent.

In one scenario, if the AI engine 112 is unable to determine the intent from information/content available in the user query, the centralized virtual assistant 108 may request the user to enrich the user query. The user may enrich the user query by supplementing additional or specific details. For example, while seeking maintenance related information, the user may also indicate a unit whose maintenance related information is required.

After the intent is determined from the user query, the AI engine 112 provides a response to the centralized virtual assistant 108, at step 408. The response may include details of the intent determined by the AI engine 112. The centralized virtual assistant 108 maps the intent to Application Programming Interfaces (APIs) of the multiple virtual assistants, for making API calls, at step 410. In present case, the centralized virtual assistant 108 maps the intent to the APIs of the virtual assistants 104-1 through 104-4.

Mapping the intent to the APIs refers to constructing an API request and may involve determining an appropriate API endpoint, parameters, and request method to send data to a backend system. The mapping process ensures that the request is formatted correctly to interact with correct API and that it retrieves or manipulates the required data. Constructing the API request may include constructing a Uniform Resource Locator (URL) to access the correct API endpoint. Some APIs may require headers for authentication, for example an API key or a bearer token.

After the intent is mapped with the API i.e. an API request is formulated, the centralized virtual assistant 108 broadcasts the user query by making API calls to each of the virtual assistants 104-1 through 104-4, at step 412. Via such broadcasting, the centralized virtual assistant 108 tries to obtain response of each of the virtual assistants 104-1 through 104-4 towards the user query. Based on their predefined functionality/configurations, one or more of the virtual assistants 104 determine responses to the user query. Each of the virtual assistants 104 processing the user query provides a response to the centralized virtual assistant 108 along with a confidence score, at step 414. The confidence score would indicate a probability/likelihood of an accuracy of response determined by a virtual assistant.

The centralized virtual assistant 108 receives responses of the virtual assistants 104 and confidence scores associated with the responses, and determines an optimal response from the responses, based on the confidence scores, at step 416. In one implementation, the optimal response may be a response associated with a confidence score of highest value. In another implementation, the optimal response may be determined by collating information present in different responses associated with confidence scores greater than a predefined cut-off value. The centralized virtual assistant 108 may communicate the optimal response to the AI engine 112 for performing Natural Language Processing (NLP), at step 418.

NLP is used to understand, interpret, and generate human language in a way that is both meaningful and useful. NLP involves a series of steps to be performed, as described ahead. Initially, textual content of the optimal response may be pre-processed by the AI engine 112. Pre-processing of the textual content may involve:
i. Tokenization for breaking text into smaller chunks, like words or phrases i.e. tokens;
ii. Stop word removal for removing common but unimportant words e.g., “the”, “and”, “in”;
iii. Lowercasing for converting all text to lowercase to avoid treating the same word differently e.g., “Apple” and “apple”; and
iv. Lemmatization or stemming for reducing words to their base or root form e.g., “running” to “run”.

After pre-processing, AI engine 112 converts the textual content into a format that could be understood, typically numerical vectors. In different implementations, below mentioned techniques could be used for format conversion.
i. Bag of Words (BoW): Represents text by counting the frequency of words without considering word order.
ii. Term Frequency-Inverse Document Frequency (TF-IDF): Weighs word frequencies by how unique they are across a set of documents.
iii. Word embeddings: Advanced methods like Word2Vec or GloVe represent words as dense vectors in a continuous vector space, capturing semantic relationships between words.

Successively, the AI engine 112 utilizes machine learning models or deep learning models to analyze and learn patterns from processed text obtained from the format conversion. The machine learning models may utilize techniques like Naive Bayes or Support Vector Machines. The deep learning models may be Recurrent Neural Networks (RNNs), Long Short-Term Memory (LSTM), or Transformer models e.g., BERT, GPT.

The AI engine 112 may also perform Natural Language Understanding (NLU) to understand meaning behind of text. NLU may involve:
i. Named Entity Recognition (NER) for identifying names of people, organizations, dates, etc.
ii. Part-of-Speech tagging for identifying grammatical role of each word (e.g., noun, verb).
iii. Sentiment analysis for determining the emotional tone of the text (positive, negative, neutral).
iv. Syntax and dependency parsing for analyzing the grammatical structure of sentences.

The AI engine 112 may further perform Natural Language Generation (NLG). NLG involves generating human-like text from data or structured input, using models like Generative Pre-trained Transformer (GPT). The AI engine 112 may also perform post-processing of an output of the model for further refinement. For example, grammar and coherence check could be performed on the output to generate an NLP response.

The AI engine 112 communicates the NLP response to the centralized virtual assistant 108, at step 420. Finally, the centralized virtual assistant 108 provides the NLP response to the user, at step 422. The NLP response may be provided in a text or audio format. To provide the NLP response in an audio format, text to audio conversion is performed using a suitable technique.

FIGS. 5a and 5b cumulatively illustrate an information flow diagram of a second method of implementing and operating a centralized virtual assistant for managing different services running in an enterprise, in accordance with an embodiment of the present disclosure. The second method begins with step 502 where a user submits a user query on the user device 110. The user query may be related to an operation running in the enterprise. For example, the user query may be submitted for obtaining status updates, operational guidance, or root cause identification. The user device 110 communicates the user query to the centralized virtual assistant 108, at step 504. The centralized virtual assistant 108 may be hosted over a locally implemented or cloud-based computing device system, for example the system 102. The centralized virtual assistant 108 is a software application designed to handle various tasks and provide services through a single, centralized interface, by interacting with multiple virtual assistants 104.

The virtual assistants 104 may correspond to software applications configured for monitoring different operations running in the enterprise. For example, the virtual assistants 104 may include Advanced Process Control (APC) agent, operations management agent, production management agent, and maintenance management agent. Each of the virtual assistants 104 may be configured to perform a specific task and provide specific assistance to users/operators. For example, the production management agent may be responsible for monitoring different production related activities in the enterprise and provide details of the production related activities to the users. Similarly, the maintenance management agent may be responsible for monitoring different maintenance related activities and provide details of the maintenance related activities to the user(s).

After receiving the user query, the centralized virtual assistant 108 sends a request to the AI engine 112 to process the user query, at step 506. The AI engine 112 refers to an AI based software application for processing the user query. The user query may be processed to determine an intent i.e. objective of the user query. To determine the intent, the AI engine 112 may perform a variety of steps including data collection and labelling. During the data collection and labelling, data may be gathered from a diverse set of queries or user inputs representing the kinds of interactions that are expected. Such data can be collected from past conversations, customer service logs, or synthetic data generation procedures. Labelling of the data may involve manual annotation of the queries with correct intent labels. For example, queries like “what's the boiler temperature?” could be labeled with an intent “System query”, and “when is the boiler expected to be working” would be labeled with “Maintenance query”.

Successively, the AI engine 112 may perform text pre-processing. Text pre-processing may involve tokenization i.e. splitting of the user query into individual words or tokens, and lemmatization/stemming i.e. reducing words to their base or root form. Thereafter, the the AI engine 112 may perform feature extraction. Feature extraction is performed for conversion of textual content into numerical features so that the user query could be fed to a machine learning model. Feature extraction may be performed using Bag of Words (BoW) i.e. representing text by counting frequency of each word in the user query. Alternatively, feature extraction may be performed using word embeddings where pre-trained embeddings like Word2Vec, GloVe, or BERT could be used to represent words in a continuous vector space, to capture semantic relationships between words.

Successively, the AI engine 112 may perform model selection and training. Intent detection is typically a classification task, and thus supervised Machine Learning (ML) algorithms can be used. For example, Logistic Regression, Support Vector Machine (SVM), Naive Bayes, and deep learning could be used. Using a suitable ML algorithm, an ML model could be implemented, successively trained, evaluated, and deployed. Upon deployment, the AI model (i.e. the AI engine 112) may classify incoming user queries in real-time i.e. determine the intent.

In one scenario, if the AI engine 112 is unable to determine the intent from information/content available in the user query, the centralized virtual assistant 108 may request the user to enrich the user query. The user may enrich the user query by supplementing additional or specific details. For example, while seeking maintenance related information, the user may also indicate a unit whose maintenance related information is required.

After the intent is determined from the user query, the AI engine 112 provides a response to the centralized virtual assistant 108, at step 508. The response may include details of the intent determined by the AI engine 112. After knowing the intent of the user query, the centralized virtual assistant 108 sends a request to a knowledge database 114 to indicate relevant virtual assistants, at step 510. The relevant virtual assistants refer to virtual assistants responsible for providing information/assistance matching with or related to the user query. The knowledge database 114 is a repository storing details of functionalities of all the virtual assistants 104. For example, details of the all the virtual assistants 104 may be stored in the knowledge database 114 in a textual format. Textual mapping or comparison may be performed between keywords of the user query or the intent and the details stored in the knowledge database 114 to identify the relevant virtual assistants. The centralized virtual assistant 108 receives the details of the relevant virtual assistants, at step 512.

For example, in one implementation, it may be determined that virtual assistant 1 104-1 and virtual assistant 2 104-2 are related to the user query or the intent. In such scenario, the centralized virtual assistant 108 maps the intent to Application Programming Interfaces (APIs) of only the virtual assistant 1 104-1 and the virtual assistant 2 104-2, for making API calls, at step 514.

Mapping the intent to the APIs refers to constructing an API request and may involve determining an appropriate API endpoint, parameters, and request method to send data to a backend system. The mapping process ensures that the request is formatted correctly to interact with correct API and that it retrieves or manipulates the required data. Constructing the API request may include constructing a Uniform Resource Locator (URL) to access the correct API endpoint. Some APIs may require headers for authentication, for example an API key or a bearer token.

After the intent is mapped with the API i.e. an API request is formulated, the centralized virtual assistant 108 sends the user query by making API calls to the virtual assistant 1 104-1 and the virtual assistant 2 104-2, at step 516. API calls 516a and 516b can be made sequentially or concurrently to the virtual assistant 1 104-1 and the virtual assistant 2 104-2 respectively.

Successively, the centralized virtual assistant 108 receives responses of the virtual assistant 1 104-1 and the virtual assistant 2 104-2, at step 518. Responses 518a and 518b of the virtual assistant 1 104-1 and the virtual assistant 2 104-2 respectively can be received sequentially or concurrently, by the centralized virtual assistant 108. The virtual assistant 1 104-1 and the virtual assistant 2 104-2 provides their response to the centralized virtual assistant 108 along with a confidence score. The confidence score would indicate a probability/likelihood of an accuracy of response determined by a virtual assistant.

The centralized virtual assistant 108 determines an optimal response from the responses of the virtual assistant 1 104-1 and the virtual assistant 2 104-2, based on the confidence scores, at step 520. In one implementation, the optimal response may be a response associated with a confidence score of highest value. In another implementation, the optimal response may be determined by collating information present in different responses associated with confidence scores greater than a predefined cut-off value. The centralized virtual assistant 108 may communicate the optimal response to the AI engine 112 for performing Natural Language Processing (NLP), at step 522.

NLP is used to understand, interpret, and generate human language in a way that is both meaningful and useful. NLP involves a series of steps to be performed, as described ahead. Initially, textual content of the optimal response may be pre-processed by the AI engine 112. Pre-processing of the textual content may involve:
v. Tokenization for breaking text into smaller chunks, like words or phrases i.e. tokens;
vi. Stop word removal for removing common but unimportant words e.g., “the”, “and”, “in”;
vii. Lowercasing for converting all text to lowercase to avoid treating the same word differently e.g., “Apple” and “apple”; and
viii. Lemmatization or stemming for reducing words to their base or root form e.g., “running” to “run”.

After pre-processing, AI engine 112 converts the textual content into a format that could be understood, typically numerical vectors. In different implementations, below mentioned techniques could be used for format conversion.
iv. Bag of Words (BoW): Represents text by counting the frequency of words without considering word order.
v. Term Frequency-Inverse Document Frequency (TF-IDF): Weighs word frequencies by how unique they are across a set of documents.
vi. Word embeddings: Advanced methods like Word2Vec or GloVe represent words as dense vectors in a continuous vector space, capturing semantic relationships between words.

Successively, the AI engine 112 utilizes machine learning models or deep learning models to analyze and learn patterns from processed text obtained from the format conversion. The machine learning models may utilize techniques like Naive Bayes or Support Vector Machines. The deep learning models may be Recurrent Neural Networks (RNNs), Long Short-Term Memory (LSTM), or Transformer models e.g., BERT, GPT.

The AI engine 112 may also perform Natural Language Understanding (NLU) to understand meaning behind of text. NLU may involve:
v. Named Entity Recognition (NER) for identifying names of people, organizations, dates, etc.
vi. Part-of-Speech tagging for identifying grammatical role of each word (e.g., noun, verb).
vii. Sentiment analysis for determining the emotional tone of the text (positive, negative, neutral).
viii. Syntax and dependency parsing for analyzing the grammatical structure of sentences.

The AI engine 112 may further perform Natural Language Generation (NLG). NLG involves generating human-like text from data or structured input, using models like Generative Pre-trained Transformer (GPT). The AI engine 112 may also perform post-processing of an output of the model for further refinement. For example, grammar and coherence check could be performed on the output to generate an NLP response.

The AI engine 112 communicates the NLP response to the centralized virtual assistant 108, at step 524. Finally, the centralized virtual assistant 108 provides the NLP response to the user, at step 526.

By implementing the above-described functionality, the centralized virtual assistant 108 provides a single point of service for obtaining information required by any user/operator in an enterprise. The centralized virtual assistant consolidates all the operations and integrations in one place. The centralized virtual assistant can be used to help manage various aspects of an organization or user's daily tasks, improve productivity, and provide a seamless user experience. The NLP response obtained by the user may be utilized in several ways, such as to understand manner of operation of a machinery, understand fault in an equipment, perform root cause analysis, etc.

The centralized virtual assistant can be utilized in several manner within an enterprise. A few important applications are described successively.
i. Improved Customer Support: The centralized virtual assistant can function as a virtual customer support agent, assisting users by answering FAQs, troubleshooting common issues, and routing more complex queries to human agents when necessary.
ii. Providing employee assistance and improving productivity by performing:
   Information Retrieval: Employees can query the centralized virtual assistant to get quick access to critical information, including company policies, internal resources, HR documents, or project updates, all in one place.
   Document and data management: The centralized virtual assistant can assist in organizing, retrieving, and managing important documents, such as contracts, invoices, and reports, by querying document management systems or cloud storage solutions.
   Knowledge sharing and collaboration: The centralized virtual assistant can act as a central hub for knowledge management, helping employees find expert resources, share knowledge, and collaborate efficiently by providing updates on project statuses, team communications, and documents.
iii. Offering workflow and process optimization by performing:
   Task and project management: The centralized virtual assistant can integrate with project management tools (like Jira, Asana, or Trello) to track the progress of tasks, send notifications, update timelines, and ensure deadlines are met.
   Business process automation: The centralized virtual assistant can automate processes across departments, such as finance, HR, and procurement. For example, it could assist with invoice approval workflows, employee onboarding, and purchase requisition processes.
iv. Performing data analysis and reporting by:
   Providing insights and dashboards: The centralized virtual assistant can pull real-time data from business intelligence tools (such as Power BI or Tableau) to generate insights and reports, helping managers and executives make informed decisions based on up-to-date performance metrics.
   Performing predictive analytics: By analyzing historical data, the centralized virtual assistant can provide predictive insights, such as sales forecasts, customer behavior trends, and inventory management recommendations.
v. Managing security and compliance by performing:
   Access management: The centralized virtual assistant can assist in managing access permissions to sensitive systems or data, ensuring employees have the correct access rights based on their roles.
   Compliance monitoring: The centralized virtual assistant can help ensure the company stays compliant with regulations (e.g., GDPR, HIPAA) by monitoring adherence to policies and assisting with data audits or reports.

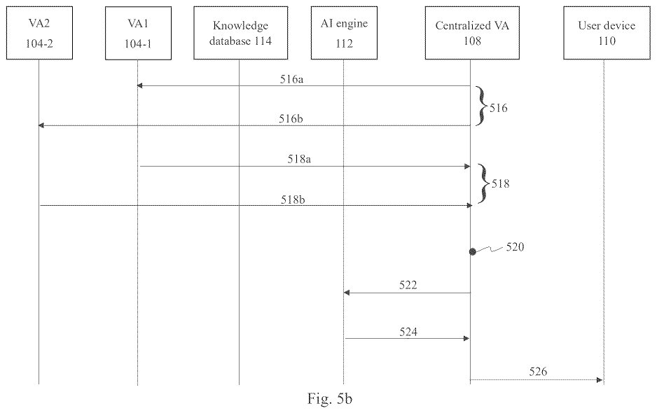

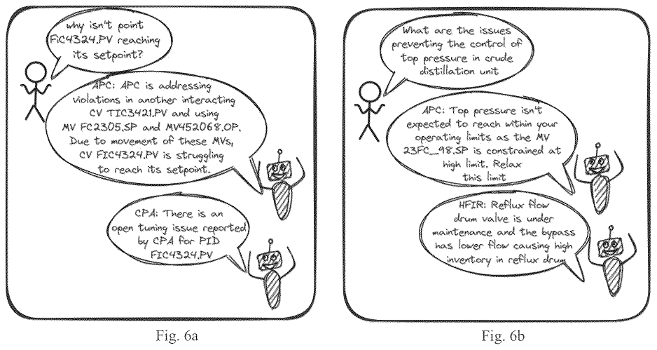

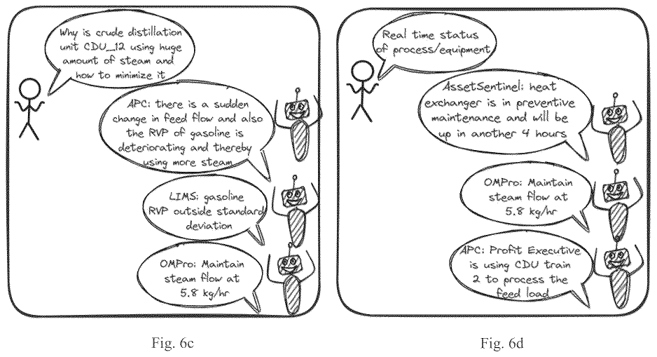

FIGS. 6a through 6d illustrate different use case scenarios of the centralized virtualized assistant for managing services, in accordance with an embodiment of the present disclosure. FIG. 6a illustrates a scenario related to increasing operator awareness. FIG. 6b illustrates a scenario related to increasing operator effectiveness. FIG. 6c illustrates a scenario related to aiding a mentor inexperienced operator. FIG. 6d illustrates a scenario related to providing a root cause status to a user.

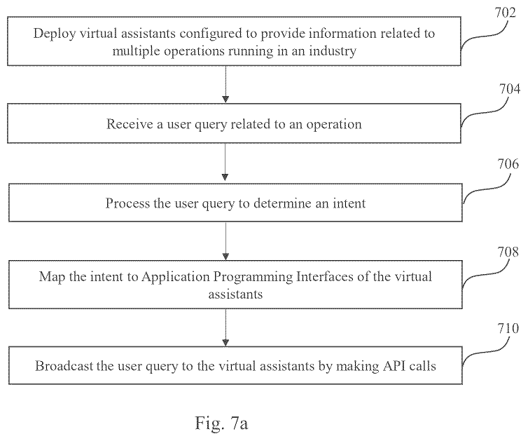

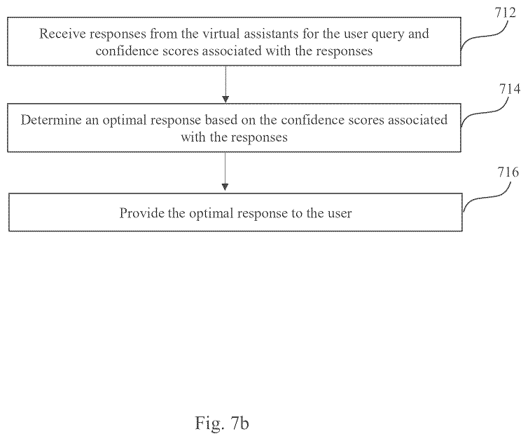

FIGS. 7a and 7b cumulatively illustrate a flow chart of a method of implementing and utilizing a centralized virtualized assistant for managing services, in accordance with an embodiment of the present disclosure. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIGS. 7a and 7b may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

At step 702, a plurality of virtual assistants is deployed. Each virtual assistant is configured to provide information related to one of a plurality of operations running in an enterprise. For example, the plurality of operations may include manufacturing operations, supply chain operations, maintenance operations, energy and utilities operations, Information Technology (IT) operations, compliance operations, and service operations.

At step 704, a user query related to one or more operations of the plurality of operations is received at a centralized virtual assistant. The user query may be provided in textual format and may be submitted for obtaining status updates, operational guidance, or root cause identification.

At step 706, the user query is processed to determine an intent i.e. objective of the user query. The user query is processed using a Machine Learning (ML) technique. To determine the intent, at first, the user query may be preprocessed. Preprocessing may involve tokenization of textual content, removal of stop words, and lemmatization. Successively, feature extraction may be performed to convert the user query into a numerical representation using TF-IDF or word embeddings. Finally, a trained ML model may be used to classify the intent.

At step 708, the intent is mapped to Application Programming Interfaces (APIs) of the plurality of virtual assistants. Mapping the intent to the APIs may involve identifying an endpoint and method, preparing an API call with necessary parameters or data, and constructing an API request.

At step 710, the user query is broadcasted to the plurality of virtual assistants by making API calls. Broadcasting the user query involves transmitting the API request to endpoints of network elements, such as servers hosting the plurality of virtual assistants.

At step 712, responses are received from the plurality of virtual assistants, towards the user query. The responses may include information related to a device operating in an enterprise or a process running in the enterprise. Further, confidence scores associated with the responses are received from the plurality of virtual assistants. The confidence scores would be indicative of a level of completeness or accuracy of the responses provided by the plurality of virtual assistants.

At step 714, an optimal response is determined based on the confidence scores associated with the responses. The optimal response may be a response associated with a confidence score of highest value. Alternatively, the optimal response may be determined by collating information present in different responses associated with confidence scores greater than a predefined cut-off value.

At step 716, the optimal response is provided to the user. The optimal response may be processed using Natural Language Processing (NLP) before providing to the user.

The machineries/equipment in whose relation the centralized virtual assistant could be utilized may be of different types depending on a type of enterprise for which the proposed system and method is implemented. For example, the machinery may be a manufacturing machinery, such as a Computerized Numeric Control (CNC) machine, lathe, or milling machine. The machinery could also be a construction machinery, such as excavator, bulldozer, or crane. The machinery could also be an agricultural machinery like tractor, harvester, or plow. The machinery could also be a mining machinery like dragline, continuous miner, or a dump truck. The machinery could also be a food processing machinery like a mixer, packaging machines, or a pasteurizer. The machinery could also be a textile machinery like a spinning machine, weaving loom, or a knitting machine. The machinery could also be a printing machinery like an offset printing press, digital printer, or a screen-printing machine. The machinery could also be a woodworking machinery like a saw, planer, or a sander.

In an Information Technology (IT) enterprise, the machinery/machine may be a server like a web server or a database server. The machine may also be a workstation like a graphics workstation or a CAD workstations. The machine may also be a personal computer like a desktop or a laptop. The machine may also be a network device like a router or a network switch. The machine may also be a storage device like a Hard Disk Drive (HDD), Solid State Drive (SSD), or a Network Attached Storage (NAS). The machine may also be a mainframe, supercomputer, or a thin client. The machine may also be an embedded system like an Internet of Things (IoT) device or an industrial control system. The machine may also be a networking equipment like firewall or access point.

The term cloud/network cloud referenced above refers to the integration of networking and cloud computing, allowing users to access, store, and manage data and applications over the internet rather than relying solely on local servers or personal devices. Network clouds enable scalability, flexibility, and cost efficiency in managing IT resources. The can be public clouds, private clouds, hybrid clouds, and multi-clouds. Through the public clouds, services are delivered over the internet and shared across multiple organizations. Providers like Amazon Web Services (AWS), Microsoft Azure, and Google Cloud Platform (GCP) offer resources that are accessible to anyone who wants to use them. The private clouds are available for exclusive use by an organization, offering greater control over data, security, and compliance. The private clouds can be hosted on-premises or by a third-party provider. The hybrid clouds combine public and private clouds, allowing data and applications to be shared between them. Organizations can maintain sensitive data on a private cloud while leveraging the scalability of a public cloud for less sensitive workloads. The multi-clouds involve using services from multiple cloud providers, which can include public, private, or hybrid clouds. Organizations may choose this approach to avoid vendor lock-in and to leverage the best services from different providers. The network clouds may provide Infrastructure as a Service (IaaS), Platform as a Service (PaaS), or Software as a Service (SaaS).

In the above description, for purposes of explanation, numerous specific details are set forth in order to provide a thorough understanding of the present systems and methods. It will be apparent the systems and methods may be practiced without these specific details. Reference in the specification to “an example” or similar language means that a particular feature, structure, or characteristic described in connection with that example is included as described, but may not be included in other examples.

Those skilled in the art will understand that any number of nodes, devices, links, etc. may be used in the cloud network, and that the view shown herein is for simplicity. Also, those skilled in the art will further understand that while the cloud network is shown in a certain orientation, the cloud network is merely an example illustration that is not meant to limit the disclosure. For example, “real-world” cloud networks may comprise any type of network, including, among others, Fog networks, IoT networks, core networks, backbone networks, data centers, enterprise networks, provider networks, customer networks, virtualized networks (e.g., virtual private networks or “VPNs”), combinations thereof, and so on. Note further that the network environments and their associated devices may also be located in different geographic locations.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

We claim:

1. A method, comprising:
deploying a plurality of virtual assistants, wherein each virtual assistant is configured to provide information related to one of a plurality of operations running in an industry;
receiving, at a centralized virtual assistant, a user query related to one or more operations of the plurality of operations;
processing the user query using a Machine Learning (ML) technique to determine an intent;
mapping the intent to Application Programming Interfaces (APIs) of the plurality of virtual assistants;
broadcasting the user query to the plurality of virtual assistants by making API calls;
receiving responses from the plurality of virtual assistants for the user query and confidence scores associated with the responses;
determining an optimal response based on the confidence scores associated with the responses; and
providing the optimal response to the user.

2. The method as claimed in claim 1, wherein the plurality of virtual assistants include Advanced Process Control (APC) agent, operations management agent, production management agent, and maintenance management agent.

3. The method as claimed in claim 1, wherein the optimal response is a response, of the responses, associated with a confidence score of highest value.

4. The method as claimed in claim 1, wherein the optimal response is determined by:
identifying two or more responses having confidence scores greater than a predefined cut-off value; and
aggregating information of the two or more responses.

5. The method as claimed in claim 1, wherein the user query is for obtaining status updates, operational guidance, and root cause identification.

6. The method as claimed in claim 1, further comprising:
generating a Natural Language Processing (NLP) response using the optimal response; and
providing the NLP response to the user.

7. The method as claimed in claim 1, further comprising requesting the user to enrich the user query when the intent cannot be determined from available content of the user query.

8. The method as claimed in claim 1, wherein the user query and the optimal response are present in one of text format and audio format.

9. A system comprising:
a processor; and
a memory coupled with the memory, wherein the memory stores program instructions configured to:
deploy a plurality of virtual assistants, wherein each virtual assistant is configured to provide information related to one of a plurality of operations running in an industry;
receive, at a centralized virtual assistant, a user query related to one or more operations of the plurality of operations;
process the user query using a Machine Learning (ML) technique to determine an intent;
map the intent to Application Programming Interfaces (APIs) of the plurality of virtual assistants;
broadcast the user query to the plurality of virtual assistants by making API calls;
receive responses from the plurality of virtual assistants for the user query and confidence scores associated with the responses;
determine an optimal response based on the confidence scores associated with the responses; and
provide the optimal response to the user.

10. The system as claimed in claim 9, wherein the plurality of virtual assistants include Advanced Process Control (APC) agent, operations management agent, production management agent, and maintenance management agent.

11. The system as claimed in claim 9, wherein the optimal response is a response, of the responses, associated with a confidence score of highest value.

12. The system as claimed in claim 9, wherein the optimal response is determined by:
identifying two or more responses having confidence scores greater than a predefined cut-off value; and
aggregating information of the two or more responses.

13. The system as claimed in claim 9, wherein the user query is for obtaining status updates, operational guidance, and root cause identification.

14. The system as claimed in claim 9, wherein the program instructions are further configured to:
generate a Natural Language Processing (NLP) response using the optimal response; and
provide the NLP response to the user.

15. The system as claimed in claim 9, wherein the program instructions are further configured to request the user to enrich the user query when the intent cannot be determined from available content of the user query.

16. The system as claimed in claim 9, wherein the user query and the optimal response are present in one of text format and audio format.

17. A non-transitory computer-readable storage medium comprising computer program code for execution by one or more processors of an apparatus, the computer program code configured to, when executed by the one or more processors, cause the apparatus to:
deploy a plurality of virtual assistants, wherein each virtual assistant is configured to provide information related to one of a plurality of operations running in an industry;
receive, at a centralized virtual assistant, a user query related to one or more operations of the plurality of operations;
process the user query using a Machine Learning (ML) technique to determine an intent;
map the intent to Application Programming Interfaces (APIs) of the plurality of virtual assistants;
broadcast the user query to the plurality of virtual assistants by making API calls;
receive responses from the plurality of virtual assistants for the user query and confidence scores associated with the responses;
determine an optimal response based on the confidence scores associated with the responses; and
provide the optimal response to the user.

18. The non-transitory computer-readable storage medium as claimed in claim 17, wherein the plurality of virtual assistants include Advanced Process Control (APC) agent, operations management agent, production management agent, and maintenance management agent.

19. The non-transitory computer-readable storage medium as claimed in claim 17, wherein the optimal response is a response, of the responses, associated with a confidence score of highest value.

20. The non-transitory computer-readable storage medium as claimed in claim 17, wherein the optimal response is determined by:
identifying two or more responses having confidence scores greater than a predefined cut-off value; and
aggregating information of the two or more responses.
